(19) United States
(12) Patent Application Publication
(10) Pub. No.: US 2009/0168722 A1
(43) Pub. Date: Jul. 2, 2009

(54) HANDOVER PROCEDURE

(76) Inventors: Yousuf Saifullah, Richardson, TX (US); Shashikant Maheshwari, Irving, TX (US); Haihong Zheng, Coppell, TX (US)

Correspondence Address: Brake Huges Bellermann LLP;c/o Intellevate, P.O.Box 52050, Minneapolis, MN, 55402, US

(21) Appl. No.: 12/246,473

(22) Filed: Oct. 6, 2008

Related U.S. Application Data
(60) Provisional application No. 60/978,245, filed on Oct. 8, 2007.

(51) Int. Cl. H04W 36/00

(52) U.S. Cl. 370/331

(57) ABSTRACT

Various example embodiments are disclosed. One example embodiment may include determining, by a serving base station in a wireless network, to hand a mobile station over to a target base station. This example may further include receiving a base station-to-base station handover message from the target base station, the base station-to-base station handover message including at least one connection identifier (CID) associated with the target base station. This example may further include sending a base station-to-mobile station handover message to the mobile station based on the determining, the handover message including the at least one CID.

### PRIORITY CLAIM

This Application claims the benefit of priority based on U.S. Provisional Application No. 60/978,245, filed on Oct. 8, 2007, entitled, “Handover Procedure,” the disclosure of which is hereby incorporated by reference.

### TECHNICAL FIELD

This description relates to wireless networks.

### BACKGROUND

Wireless networks may include one or more base stations which serve mobile stations within their respective geographical area, often called a “cell.” When a mobile station moves out of the cell of a first base station, often called a “serving base station,” and into the cell of a second base station, often called a “target base station,” the mobile station may be “handed over” from the serving base station to the target base station.

### SUMMARY

According to one general aspect, a serving base station may determine, in a wireless network, to hand a mobile station over to a target base station. The serving base station may also receive a base station-to-base station handover message from the target base station, the base station-to-base station handover message including at least one connection identifier (CID) associated with the target base station. The serving base station may also send a base station-to-mobile station handover message to the mobile station based on the determining, the handover message including the at least one CID.

According to another general aspect, a mobile station in a wireless network may determine to hand over from a serving base station to a target base station. The mobile station may also receive a handover message from the serving base station, the handover message including at least one connection identifier (CID). The mobile station may also establish a connection with the target base station using the at least one CID.

According to another example embodiment, a target base station in a wireless network may receive a base station-to-base station handover message from a serving base station, the base station-to-base station handover message identifying a mobile station to hand over to the target base station. The target base station may also send a scheduling message to the identified mobile station based on the received handover message, the scheduling message including at least one connection identifier (CID). The target base station may also receive a range request from the mobile station via a channel identified in the scheduling message.

According to another general aspect, a target base station in a wireless network may receive a handover message from a serving base station providing service to a mobile station. The target base station may also send a scheduling message to the mobile station in response to receiving the handover request. The target base station may also receive a data packet from the mobile station without receiving a range request, the data packet being received in accordance with the scheduling message and including an authentication code and/or an encryption code.

According to another general aspect, a mobile station in a wireless network may transmit to a target base station a range request message, the range request message identifying an old connection identifier (CID) that was used by a serving base station for the mobile station. The mobile station may also transmit one or more packets from the mobile station to the target base station using the old CID.

According to another general aspect, a mobile station in a wireless network may receive a message from a target base station. The mobile station may also determine, based on the received message, whether an old connection identifier (CID) that was used by a serving base station for the mobile station or a new CID for the mobile station should be used for communication with the target base station. The mobile station may also transmit a range request message to the target base station, the range request message identifying either the old CID or the new CID based on the determining. The mobile station may also transmit one or more packets to the target base station using either the old CID or a new CID based on the determining.

According to another general aspect, a mobile station in a wireless network may use a first connection identifier (CID) for communication with a serving base station. The mobile station may also perform a handover from the serving base station to a target base station. The mobile station may also continue to use the first CID for communication with the target base station.

According to another general aspect, a target base station in a wireless network may receive, from a serving base station, a request to use an old connection identifier (CID) for communication with a mobile station, the old CID being owned by a different base station. The target base station may also determine that communication may be performed between the target base station and the mobile station using the old CID. The target base station may also communicate with the mobile station using the old CID for the mobile station.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram showing a wireless network according to an example embodiment in which a mobile station moves from a serving cell served by a serving base station into a target cell served by a target base station, according to an example embodiment.

FIG. 2A is a vertical-time sequence diagram showing a handover procedure according to an example embodiment in which the serving base station and the target base station communicate via a gateway and the handover is initiated by the mobile station, according to an example embodiment.

FIG. 2B is a vertical-time sequence diagram showing a handover procedure according to an example embodiment in which the serving base station and the target base station communicate via the gateway and the handover is initiated by the serving base station, according to an example embodiment.

FIG. 2C is a vertical-time sequence diagram showing a handover procedure according to an example embodiment in which the serving base station and the target base station communicate directly with each other and the handover is initiated by the mobile station, according to an example embodiment.

FIG. 2D is a vertical-time sequence diagram showing a handover procedure according to an example embodiment in which the serving base station and the target base station communicate directly with each other and the handover is initiated by the serving base station, according to an example embodiment.

FIG. 3A is a vertical-time sequence diagram showing a handover procedure according to an example embodiment in which the serving base station and the target base station communicate via the gateway and the handover is initiated by the mobile station, according to another example embodiment.

FIG. 3B is a vertical-time sequence diagram showing a handover procedure according to an example embodiment in which the serving base station and the target base station communicate via the gateway and the handover is initiated by the serving base station, according to another example embodiment.

FIG. 3C is a vertical-time sequence diagram showing a handover procedure according to an example embodiment in which the serving base station and the target base station communicate directly with each other and the handover is initiated by the mobile station, according to another example embodiment.

FIG. 3D is a vertical-time sequence diagram showing a handover procedure according to an example embodiment in which the serving base station and the target base station communicate directly with each other and the handover is initiated by the serving base station, according to another example embodiment.

FIG. 4 is a block diagram of a packet according to an example embodiment.

FIG. 5A is a vertical-time sequence diagram showing a base station request a CID controller to allocate a CID to the base station.

FIG. 5B is a vertical-time sequence diagram showing a base station request the CID controller to de-allocate the CID from the base station.

FIG. 6 is a flowchart showing a method according to an example embodiment.

FIG. 7 is a flowchart showing a method according to another example embodiment.

FIG. 8 is a flowchart showing a method according to another example embodiment.

FIG. 9 is a block diagram of a wireless station according to an example embodiment.

### DETAILED DESCRIPTION

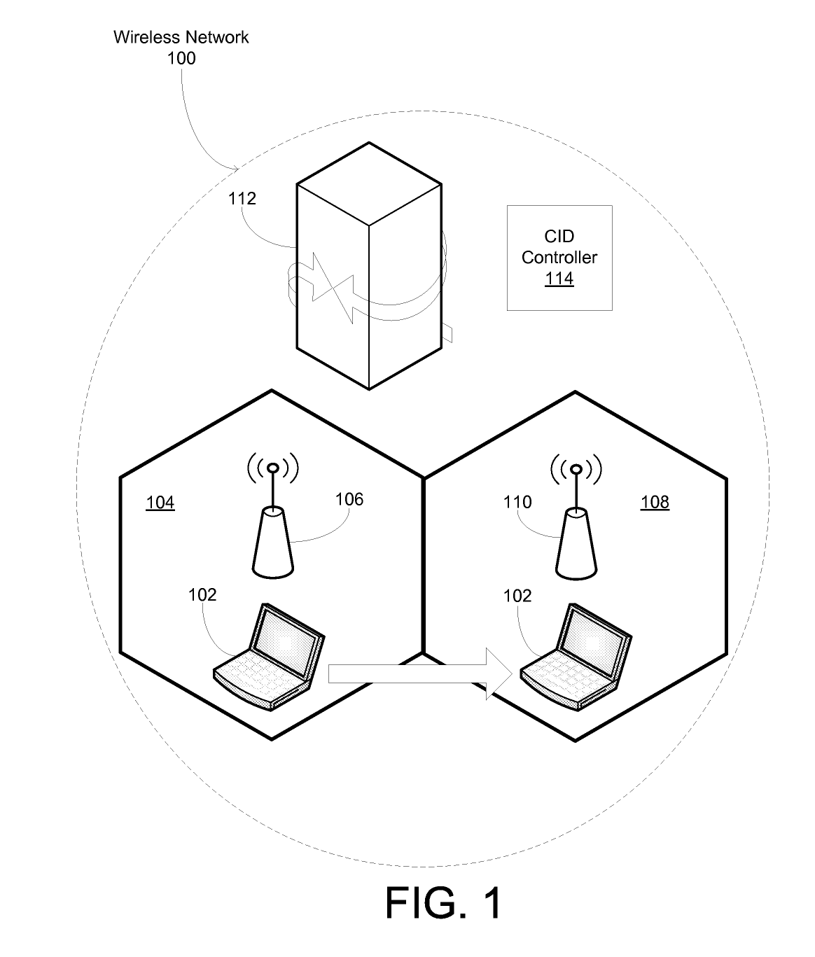

FIG. 1 is a diagram showing a wireless network 100 according to an example embodiment in which a mobile station 102 moves from a serving cell 104 served by a serving base station 106 into a target cell 108 served by a target base station 110, according to an example embodiment. The wireless network 100 may include, for example, an IEEE 802.16 wireless metropolitan area network (WiMAX), an IEEE 802.11 wireless local area network (WLAN), or a cellular telephone network, according to example embodiments. The wireless network 100 may provide data and/or voice service to one or more user terminals such as the mobile station 102.

The wireless network 100 may be divided into cells, such as the serving cell 104 and the target cell 108. While the serving cell 104 and the target cell 108 are shown as hexagonal in FIG. 1 for illustrative purposes, the cells within the wireless network 100 may be of any shape, which shape may be determined by factors such as the locations available to install base stations, as well as signal propagation factors such as geographical features and the locations of interfering objects such as buildings. Each cell, such as the serving cell 104 and the target cell 108, may be served by a base station, such as the serving base station 106 and the target base station 110. The serving base station 106 and target base station 110 may include, for example, access points (APs), cellular base stations, or node Bs, according to example embodiments.

The mobile station 102 may include, for example, a laptop or notebook computer, a personal digital assistant (PDA), a smartphone, or a cellular telephone, according to example embodiments. The mobile station 102 may receive data and/or voice service from the wireless network 100. The mobile station 102 may be located in a cell, such as the serving cell 104 or the target cell 108, served by a base station such as the serving base station 106 or the target base station 110, respectively.

The mobile station 102 may transmit and receive data from the serving base station 106 and/or the target base station 110 using, for example, time division duplexing (TDD) or frequency division duplexing (TDD), in either full or half-duplex mode. The mobile station 102 may communicate with the serving base station 106 and/or the target base station 110 using, for example, orthogonal frequency division multiple access (OFDMA), by modulating data onto a plurality of carriers, such as 256 subcarriers, according to an example embodiment. The data may be modulated onto the subcarriers using, for example, quadrature amplitude modulation (QAM) such as 64-QAM or 16-QAM, quadrature phase shift keying (QPSK), or binary phase shift keying (BPSK), according to example embodiments. The data may be arranged into packets, such as MAC packet data units (MPDUs), according to an example embodiment.

The mobile station 102 may enter the wireless network 100, such as by powering on or by moving into the wireless network 100. Upon the mobile station's 102 entry into the wireless network 100, such as an entry into the serving cell 104, a base station such as the serving base station 106 may assign one or more connection identifiers (CIDs) to the mobile station 102. The CIDs may be used to identify each user terminal, including the mobile station 102, within the serving cell 104; each CID may be unique within the serving cell 104. Each user terminal may be assigned distinct CIDs for communication in the uplink (user terminal to base station) and the downlink (base station to user terminals) directions. Each user terminal, including the mobile station 102, may be associated with a plurality of CIDs. For example, the serving base station 106 may assign to the mobile station 102 a basic CID used for high priority management messages such as handovers, a primary CID used for lower priority management messages such as admission control, a secondary CID assigned using dynamic host configuration protocol (DHCP) for Internet Protocol-related messages, and/or a transport CID used to generate traffic. The transport CID may be assigned to the mobile station 102 when data flows to the mobile station 102, according to an example embodiment.

After entry into the wireless network 100, the mobile station 102 may, for example, move from one cell to another, such as from the serving cell 104 to the target cell 108. At some time during the move from the serving cell 104 to the target cell 108, the mobile station 102 may stop receiving service from the serving base station 106 and begin receiving service from the target base station 110. In this example, the serving base station 106 may hand the mobile station 102 over to the target base station 110. The handover of the mobile station 102 from the serving base station 106 to the target base station 110, which may prevent any discontinuity in service received by the mobile station 102, may include a handover procedure which includes communication between the serving base station 106 and the target base station 110.

The serving base station 106 and the target base station 110 may communicate with each other directly, via relay nodes (not shown, and which may be considered a form of direct communication if the relay nodes forward messages between the serving base station 106 and the target base station 110), or via a gateway 112. The gateway 112, which may include an Access Service Network Gateway or a mobile switching center according to example embodiments, may communicate in a wired or wireless manner with the serving base station 106 and the target base station 110. The gateway 112 may, for example, manage resources and/or facilitate handovers within the wireless network 100.

The wireless network 112 may also include a CID controller 114, according to an example embodiment. The CID controller 114 may be included in the gateway 112, or may be a separate node from the gateway 112. The CID controller 114 may be in wired or wireless communication with the gateway 112 and/or the base stations such as the serving base station 106 and the target base station 110. The CID controller 114 may assign CIDs to base stations such as the serving base station 106 and/or target base station 110. The CID controller 114 maintain a log of CIDs which are “borrowed” or “loaned” between base stations, and may allocate or de-allocate CIDs to or from base stations. The serving base station 106 and/or the target base station 110 may also maintain a log of CIDs which are “borrowed” or “loaned” between base stations, and may allocate or de-allocate CIDs to mobile stations.

During or after the handover of the mobile station 102 from the serving base station 106 to the target base station 110, it may be useful to determine the CID(s) which the mobile station 102 will use when receiving service from the target base station 110. It may also be useful for the mobile station 102 to authenticate itself to the target base station 110.

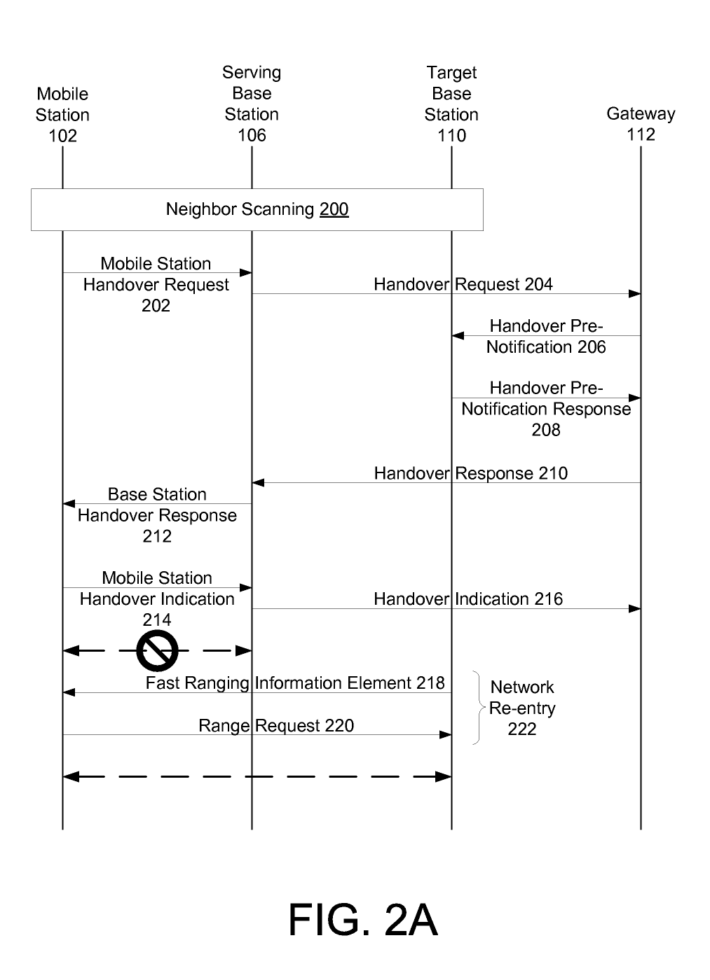

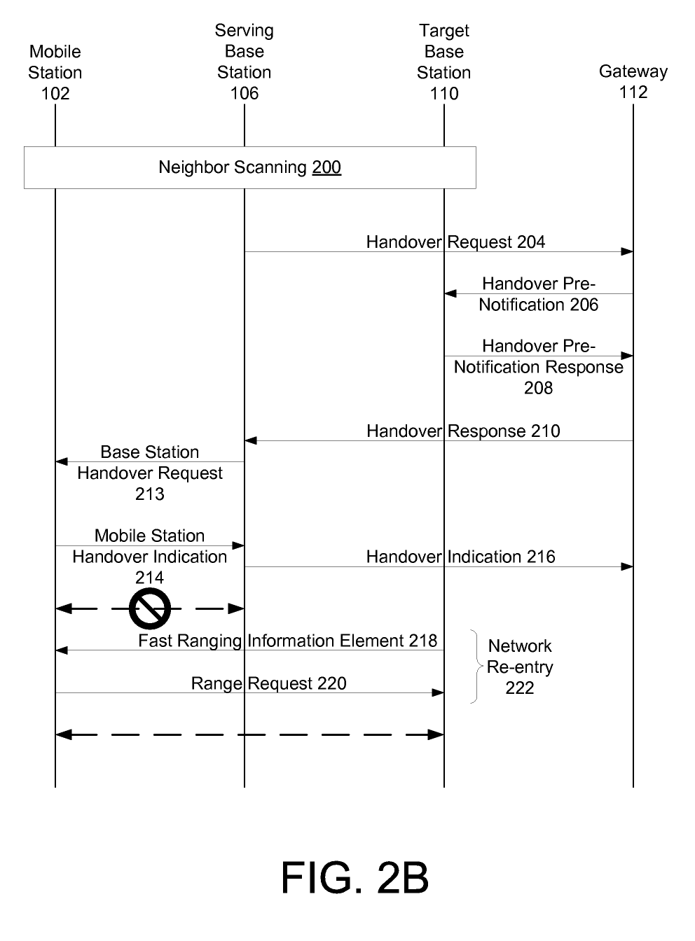

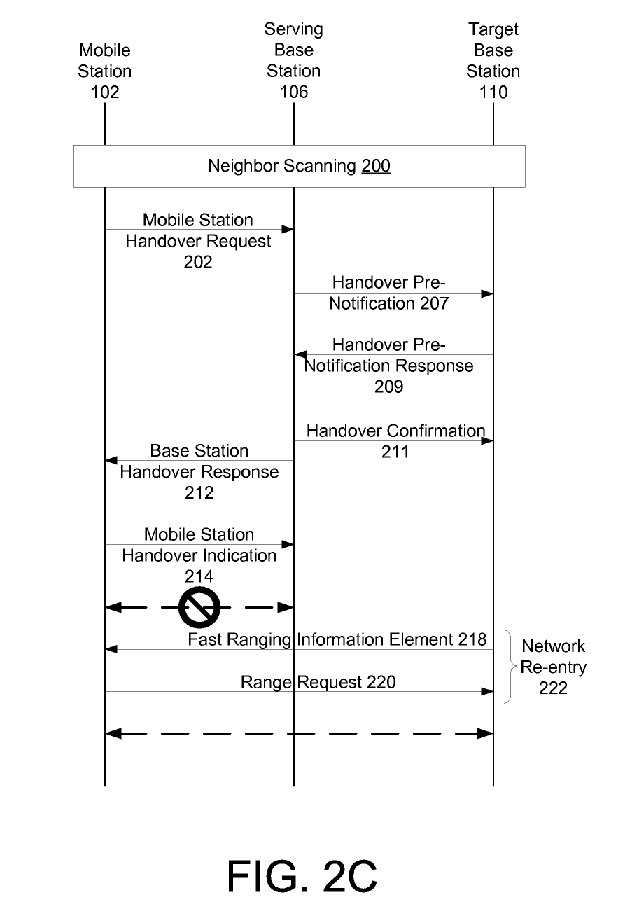

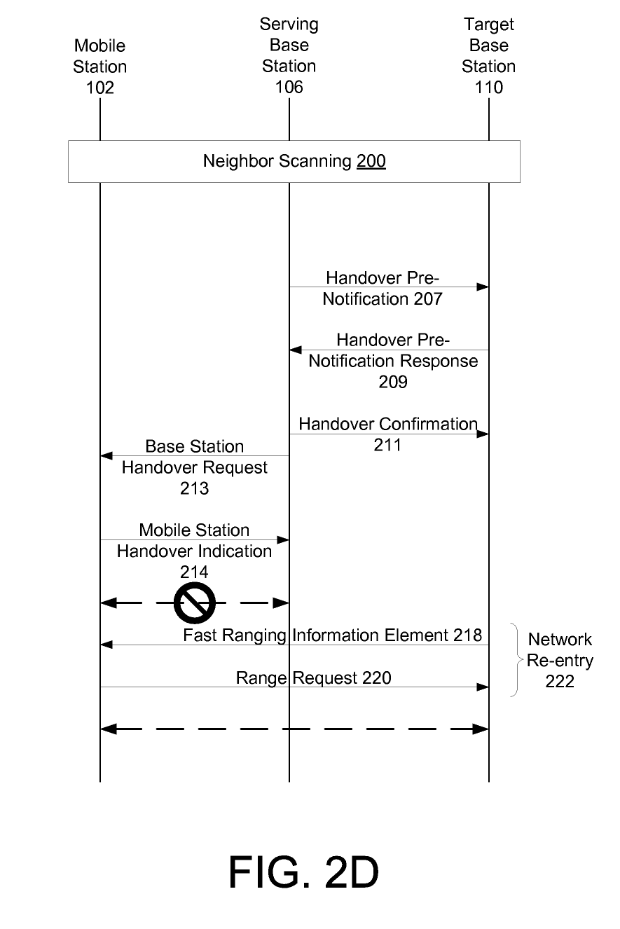

FIG. 2A is a vertical-time sequence diagram showing a handover procedure according to an example embodiment in which the serving base station 106 and the target base station 110 communicate via the gateway 112 and the handover is initiated by the mobile station 102, according to an example embodiment.

In this example, the mobile station 102, serving base station 106, and target base station 110 may perform neighbor scanning 200. In performing neighbor scanning 200, the serving base station 106 and target base station 110 may send, to each of the user terminals (including the mobile station 102) within their respective cells 104, 108 a list of neighboring user terminals. The list of neighboring user terminals may include user terminals within a predetermined distance or with a determined signal strength from each user terminal. In response to receiving the list of neighboring user terminals, the user terminals, including the mobile station 102, may scan the vicinity for the user terminals identified in the list of neighboring user terminals. The user terminals, including the mobile station 102, may send a response to the serving base station 106 and/or target base station 110. The response may include, for example, which user terminals were detected, their respective signal strengths, and/or their carrier frequencies.

The mobile station 102 may determine to hand over from the serving base station 106 to the target base station 110. The mobile station 102 may determine to hand over based, for example, on a determined distance of the mobile station 102 from the serving base station 106 and/or the target base station 110, a received signal strength measured by the mobile station 106 or by the serving base station 106 falling below a handover threshold, a received signal strength from the serving base station 106 falling below a received signal strength of the target base station 110, a determined location of the mobile station 102 (which may be determined by the mobile station 102, the serving base station 106, the target base station 110, and/or the gateway 112), and/or a predicted location of the mobile station 102 (such as based on current location and velocity).

Based on determining to handover from the serving base station 106 to the target base station 110, the mobile station 102 may send a mobile station-to-base station handover message, such as a mobile station handover request message 202, to the serving base station 106. The mobile station handover request message 202 may indicate, for example, that the mobile station 102 wishes to handover to a different base station, and may identify the target base station 110 to which the mobile station 102 wishes to be handed over.

In response to receiving the mobile station handover request message 202 from the mobile station 102, the serving base station 106 may engage in a “handshake” procedure with the target base station 110. The handshake procedure may include sending a base station-to-base station handover message, requesting to hand the mobile station 102 over to the target base station 110, and receiving a base station-to-base station message from the target base station 110. The base station-to-base station handover message may identify the mobile station 102 to be handed over to the target base station 110. The base station-to-base station handover message may include sending a list of CIDs and/or service flow identifiers (SFIDs) associated with the mobile station 102 from the serving base station 106 to the target base station.

In the example shown in FIG. 2A, the serving base station 106 may send the base station-to-base station handover message to the target base station 110 by sending a handover request message 204 to the gateway 112. The handover request message 204 may include the list of CIDs and/or SFIDs associated with the mobile station 102. The gateway 112 may, in response to receiving the handover request message 204 from the serving base station 106, send a handover pre-notification message 206, which may include the list of CIDs and/or SFIDs, to the target base station 110.

Receiving the base station-to-base station handover message by the target base station 110 may include receiving a message authentication code for the mobile station 102. The target base station 110 may receive the message authentication code from the serving base station 106, such as by the gateway forwarding the message authentication code from the serving base station 106 to the target base station 110, or from the gateway 112, which may have stored the message authentication code.

In response to receiving the base station-to-base station handover message from the serving base station 106, such as by receiving the handover pre-notification message 206 from the gateway 112, the target base station 110 may send a base station-to-base station message, accepting the request to hand over the mobile station 102, to the serving base station 106. The base station-to-base station message may include a new list of CIDs and/or SFIDs, according to an example embodiment. The target base station 110 may send the base station-to-base station message accepting the request based, at least in part, on a determination by the target base station 110 and/or the gateway 112 that the target base station 110 has sufficient spectral resources to serve the mobile station 102. In the example shown in FIG. 2A, the target base station 110 may send the base station-to-base station message accepting the request by sending a handover pre-notification response message 208 to the gateway 112. The handover pre-notification response message 208 may include the new list of CIDs and/or SFIDs. In response to receiving the handover pre-notification response message 208 from the target base station 110, the gateway 112 may send a handover response message 210, which may include the new list of CIDs and/or SFIDs, to the serving base station 106.

The base station-to-base station message sent from the target base station 110 to the serving base station 106, which may include the handover response message 210 shown in FIG. 2A, may identify the target base station 110 or a plurality of base stations to which the mobile station 102 may hand over, and may include one or more CIDs associated with the base station(s), such as the target base station 110, to which the mobile station 102 may hand over. The CIDs may include, for example, a basic CID, a primary CID, a secondary CID, and/or a transport CID associated with each of the base stations to which the mobile station 102 may hand over.

In response to receiving the base station-to-base station message from the target base station 110, such as by receiving the handover response message 210 from the gateway 112, the serving base station 106 may send a base station-to-mobile station handover message to the mobile station 102. In the example shown in FIG. 2A, the base station-to-mobile station handover message may include a base station handover response message 212. The base station handover response message 212 may, for example, identify the target base station 110 or the plurality of base stations to which the mobile station 102 may hand over.

In an example embodiment, the base station handover response message 212 may also include the one or more CIDs associated with the base station(s), such as the target base station 110, to which the mobile station 102 may hand over. In another example embodiment, the base station handover response message 212 may not include the one or more CIDs associated with the base station(s). In this latter example, the mobile station 102 may receive one or more CIDs associated with the target base station 110 from the target base station 110, such as within a fast ranging information element or uplink map, discussed below.

In response to receiving the base station handover response message 212 from the serving base station 106, the mobile station 102 may determine which base station, such as the target base station 110, to handover to. Also in response to receiving the base station handover response message 212, and/or based on the determining which base station to hand over to, the mobile station 102 may send a mobile station handover indication message 214 to the serving base station 106. The mobile station handover indication message 214 may indicate, for example, to which base station, such as the target base station 110, the mobile station 102 will hand over, and/or how the mobile station 102 will perform the handover.

In response to receiving the mobile station handover indication message 214, the serving base station 106 may send a handover indication message 216 to the gateway 112. The handover indication message 216 may indicate, for example, to which base station, such as the target base station 110, the mobile station 102 will hand over, and/or how the mobile station 102 will perform the handover, as indicated by the mobile station handover indication message 214.

In the example embodiment shown in FIG. 2A, the mobile station 102 and the serving base station 106 may stop communicating with each other, as shown by the ‘not’ sign across the double arrow between the mobile station 102 and the serving base station 106, after the mobile station 102 sends the mobile station handover indication message 214 to the serving base station 106.

The target base station 110 may send a scheduling message to the mobile station 102. The scheduling message, such as a fast ranging information element 218, may, for example, include an uplink map. The uplink map may inform the mobile station 102 of channels, such as time and/or frequency slots, via which to send packets, such as MAC packet data units (MPDUs) to the target base station 110, and a channel via which to send a range request message 220, discussed below.

In an example embodiment, the fast ranging information element 218 may also include one or more CIDs associated with the target base station 110. The one or more CIDs may include, for example, a basic CID, a primary CID, a secondary CID, and/or a transport CID associated with the target base station 110.

In response to receiving the scheduling message such as the fast ranging information element 218 from the target base station 110, the mobile station 102 may send a range request 220 to the target base station 110. The mobile station 102 may send the range request 220 via one or more of the channels identified in the scheduling message, fast ranging information element 218, and/or uplink map. A network re-entry procedure 222 may include the target base station 110 sending the scheduling message or fast ranging information element 218 to the mobile station 110 and the mobile station 102 sending the range request 220 to the target base station 110. The ranging request 220 may, for example, include at least one of the one or more CIDs included in the fast ranging information element. The range request 220 may also include a message authentication code authenticating the mobile station 102 to the target base station 110. The message authentication code may, for example, have been assigned to the mobile station 102 upon the mobile station's 102 entry into the wireless network 100 in the serving cell 104.

The mobile station 102 and the target base station 110 may thereafter communicate with each other, and the target base station 110 may provide data and/or voice service to the mobile station 102, as shown by the double arrows connected by the dashed lines. According to an example embodiment, data packets sent from the mobile station 102 to the target base station may include an authentication code or an encryption code.

FIG. 2B is a vertical-time sequence diagram showing a handover procedure according to an example embodiment in which the serving base station 106 and the target base station 110 communicate via a gateway 112 and the handover is initiated by the serving base station 106, according to an example embodiment. In this example, the mobile station 102 may not make the determination to handover to the target base station 110 or send the mobile station handover request message 202 to the serving base station 106. In this example, the serving base station 106 may determine to hand the mobile station 102 over to the target base station 110. This determination may be made based on factors similar to the factors upon which the mobile station 102 determined to hand over to the target station, in the example described with reference to FIG. 2A.

Based on determining to hand the mobile station 102 over to the target base station 110, the serving base station 106 may send the base station-to-base station handover message to the target base station 110, such as by sending the handover request message 204 to the gateway 112. In response to sending the base station-to-base station handover message to the target base station 110, the serving base station 106 may receive the base station-to-base station message accepting the request to hand over the mobile station 102 from the target base station 110, such as by receiving the handover response message 210 from the gateway 112.

In response to receiving the base station-to-base station message from the target base station 110, the serving base station 106 may send a base station-to-mobile station handover message, such as a base station handover request 213, to the mobile station 102. The base station handover request message 213 may, for example, identify the target base station 110 or the plurality of base stations to which the mobile station 102 should hand over. In an example embodiment, the base station handover request message 213 may also include the one or more CIDs associated with the base station(s), such as the target base station 110, to which the mobile station 102 should hand over. In another example embodiment, the base station handover request message 213 may not include the one or more CIDs associated with the base station(s). In this latter example, the mobile station 102 may receive one or more CIDs associated with the target base station 110 from the target base station 110, such as within the scheduling message or fast ranging information element 218, discussed with reference to FIG. 2A.

FIG. 2C is a vertical-time sequence diagram showing a handover procedure according to an example embodiment in which the serving base station 106 and the target base station 110 communicate directly with each other and the handover is initiated by the mobile station 102, according to an example embodiment. Except as otherwise described below, the handover procedure shown in FIG. 2C may be similar to the handover procedure described with reference to FIG. 2A.

In the example handover procedure shown in FIG. 2C, the serving base station 106 may send the base station-to-base station handover message to the target base station 110 by sending a handover pre-notification message 207 directly to the target base station 110. The handover pre-notification message 207 may include an inquiry as to whether the target base station 110 has sufficient spectral resources to serve the mobile station 102. The handover pre-notification message 207 may also include a list of CIDs and/or SFIDs associated with the mobile station 102, according to an example embodiment.

In response to receiving the handover pre-notification message 207, the target base station 110 may send a base station-to-base station message to the serving base station by sending, for example, a handover pre-notification response message 209 to the serving base station 106. The handover pre-notification response message 209 may indicate that the target base station 110 has sufficient spectral resources to serve the mobile station 102. The handover pre-notification message 209 may also include a new list of CIDs and/or SFIDs, according to an example embodiment.

In response to receiving the handover pre-notification message 209 from the target base station 110, the serving base station 106 may send a handover confirmation message 211 to the target base station 110. The handover confirmation message 211 may confirm that the serving base station 106 will hand the mobile station 102 over to the target base station 110. In this example, the handshake procedure may include the handover pre-notification message 207, the handover pre-notification response message 209, and the handover confirmation message 211. The message authentication code may have been included in the handover pre-notification message 207 and/or the handover confirmation message 211, according to example embodiments.

FIG. 2D is a vertical-time sequence diagram showing a handover procedure according to an example embodiment in which the serving base station 106 and the target base station 110 communicate directly with each other and the handover is initiated by the serving base station 106, according to an example embodiment. In this example, the serving base station 106 may determine to hand the mobile station 102 over to the target base station 110, as described with reference to FIG. 2B. However, in this example, the base station-to-base station handover message sent from the serving base station 106 and the base station-to-base station message sent from the target base station 110 to the serving base station 106 may include the handover pre-notification message 207, handover pre-notification response message 209, and handover confirmation message 211 described with reference to FIG. 2C.

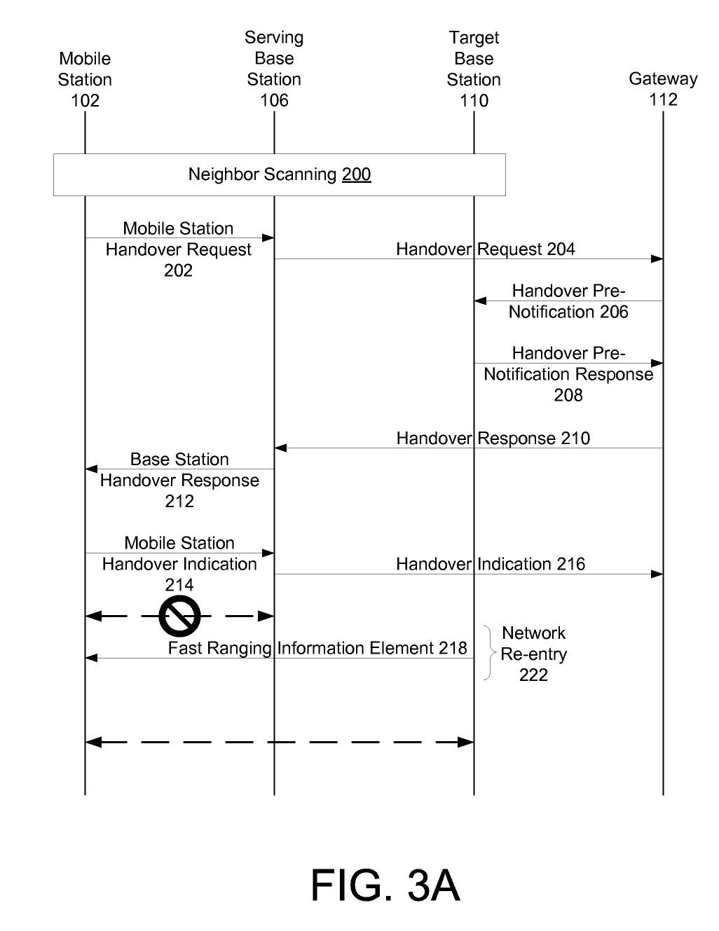

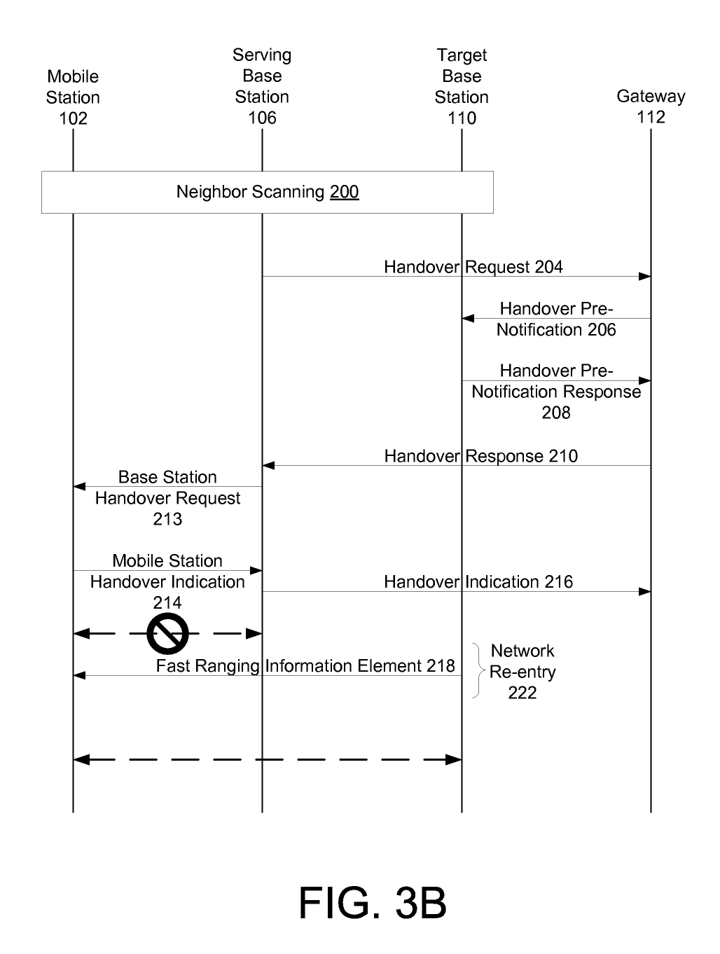

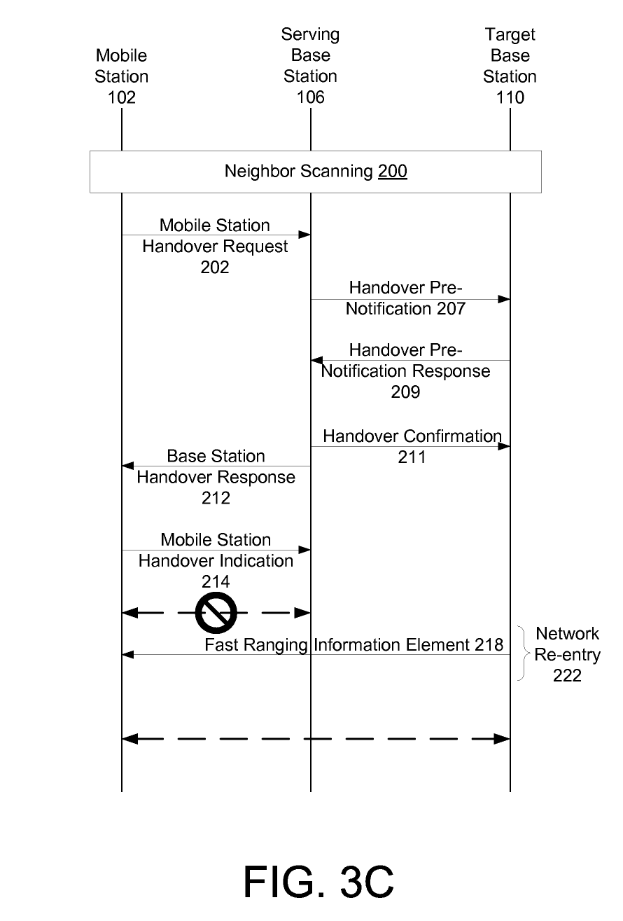

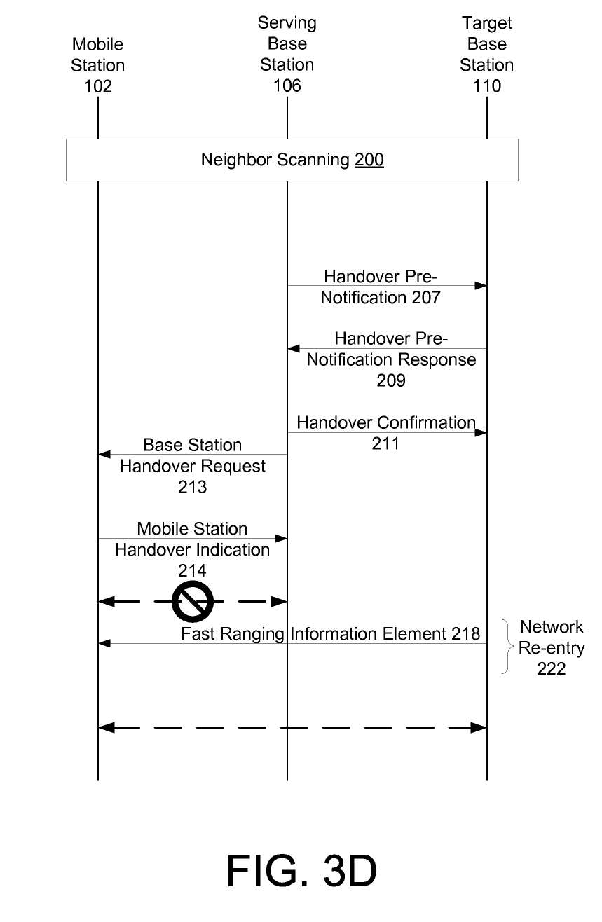

FIG. 3A is a vertical-time sequence diagram showing a handover procedure according to an example embodiment in which the serving base station 106 and the target base station 110 communicate via the gateway 112 and the handover is initiated by the mobile station 102, according to another example embodiment. In this example, the handover procedure may be similar to that described with reference to FIG. 2A; the CIDs may be included in the base station handover response 212 or the fast ranging information element 218. In this example, the network re-entry procedure 222 may include the target base station 110 sending the scheduling message for fast ranging information element 218 to the mobile station 102.

In the example shown in FIG. 3A, the mobile station 102 may not send the range request 220 (not shown in FIG. 3A), which included the message authentication code, to the target base station 110. Instead, the mobile station 102 and the target base station 110 may communicate by sending packets, such as MPDUs, to each other, as shown by the double arrow connected by a dashed line. The packets may include the message authentication code, authenticating packets as being sent from the mobile station 102 to the target base station 110, and authenticating packets as being sent from the target base station 110 to the mobile station 102. The target base station 110 may recognize the message authentication code included in the packets, and authenticate the mobile station 102 based on the message authentication code included in the packets.

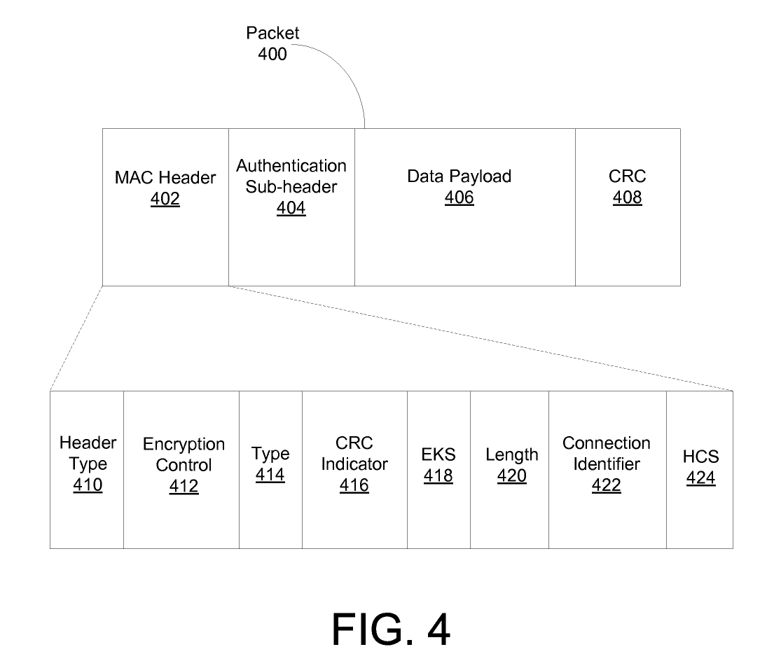

FIG. 4 is a block diagram of a packet 400 according to an example embodiment. In this example, the packet 400 may include a MAC header 402, an authentication sub-header 404, a data payload 406, and a cyclic redundancy code (CRC) 408.

The MAC header 402 may include six bytes, according to an example embodiment. The MAC header 402 may, for example, include a one-bit header type field 410, which may indicate whether the MAC header 402 is a generic MAC header or a bandwidth request header. The MAC header 402 may also include a one-bit encryption control field 412, which may indicate whether the data payload 406 is encrypted. The MAC header 402 may also include a six-bit type field 414, which may indicate the presence or absence of special extension headers for functionalities such as meshed networks, ARQ feedback, fragmentation, downlink fast feedback allocation, and/or grant management. The MAC header 402 may also include a one-bit CRC indicator field 416, which may indicate whether the packet 400 includes the cyclic redundancy code 408. The MAC header 402 may also include a two-bit EKS field 418, which may index a traffic encryption key and/or initial vector. The MAC header 402 may also include an eleven-bit length field 420, which may indicate the length of the packet 400. The connection identifier field 422 may include the CID, which identifies the mobile station 102 to or from which the packet 400 is sent. The MAC header 402 may also include an HCS field 424, which may include a header check sequence to protect misinterpretation of the MAC header 402 due to transmission errors.

The authentication sub-header 404 may include the message authentication code. The message authentication code may, for example, include a hashed message authentication code (HMAC) and/or a ciphered message authentication code (CMAC). The message authentication code may authenticate the mobile station 102 to the target base station 110. The message authentication code may, for example, include a code generated by encrypting a portion or all of the MAC header 402, such as the connection identifier field 422, with a key known to the mobile station 102 and the target base station 110. Or, the message authentication code may be generated by encrypting a portion or all of the MAC header 402 with a key known to the mobile station 102, such as a private key, and may be decrypted with a key known to the target base station 110, such as a public key.

The data payload 406 may include the data, such as voice or data, sent via the packet 400. The data payload 406 may also include a MAC address of the mobile station 102, such as when the packet 400 is included in the range request message 220. The CRC 408 may include parity bits used for error detection.

FIG. 3B is a vertical-time sequence diagram showing a handover procedure according to an example embodiment in which the serving base station 106 and the target base station communicate 110 via the gateway and the handover is initiated by the serving base station 106, according to another example embodiment. The handover procedure shown in FIG. 3B is similar to that described with reference to FIG. 2B, with the exception that instead of the mobile station 102 authenticating itself to the target base station 110 by sending the range request 220 (not shown in FIG. 3B), the packets 400 sent by the mobile station 102 to the target base station 110 may include the message authentication code, as described with reference to FIGS. 3A and 4.

FIG. 3C is a vertical-time sequence diagram showing a handover procedure according to an example embodiment in which the serving base station 106 and the target base station 110 communicate directly with each other and the handover is initiated by the mobile station 102, according to another example embodiment. The handover procedure shown in FIG. 3C is similar to that described with reference to FIG. 2C, with the exception that instead of the mobile station 102 authenticating itself to the target base station 110 by sending the range request 220 (not shown in FIG. 3C), the packets 400 sent by the mobile station 102 to the target base station 110 may include the message authentication code, as described with reference to FIGS. 3A and 4.

FIG. 3D is a vertical-time sequence diagram showing a handover procedure according to an example embodiment in which the serving base station and the target base station communicate directly with each other and the handover is initiated by the serving base station, according to another example embodiment. The handover procedure shown in FIG. 3D is similar to that described with reference to FIG. 2D, with the exception that instead of the mobile station 102 authenticating itself to the target base station 110 by sending the range request 220 (not shown in FIG. 3D), the packets 400 sent by the mobile station 102 to the target base station 110 may include the message authentication code, as described with reference to FIGS. 3A and 4.

According to an example embodiment, CIDs may be allocated to base stations, such as the serving base station 106 and the target base station 110, in such a manner that the CIDs associated with mobile stations 102 are unique not merely within each cell, but may be unique within a “CID reuse group.” A CID reuse group may include a plurality of cells, such as the serving cell 104 and the target cell 108, which may or may not be contiguous. The CID controller 114, for example, may maintain a log of unique CIDs and assign CIDs to the base stations, which may be considered as the “owners” of the CIDs which they have been assigned, in such a manner that no CID will be owned by more than one base station within the frequency reuse group.

In one example, in which each CID is identified by a plurality of bits, such as sixteen bits, some of the bits, such as the ‘n’ most significant bits, may be reserved as a base station index. For example, if each CID is a sixteen-bit identifier used to uniquely identify the connection between the mobile station 102 and a base station such as the serving base station 106 or target base station 110, three, four, or five of the most significant bits of the sixteen-bit identifier may identify the base station which owns the CIDs. If four of the sixteen bits are reserved to identify the base station, the CID reuse group may include up to sixteen base stations, and each base station may use the twelve remaining bits to identify up to 4,096 CIDs which it may own. The twelve bits may be used to identify basic, primary, secondary, and/or traffic CIDs.

According to another example, the CID controller 114 may dynamically allocate CIDs to the base stations based on the number of user terminals or mobile stations 102 within the base stations' respective user cells. Base stations with more mobile stations 102 within their cells may be allocated more CIDs, and base stations with fewer mobile stations 102 may be allocated fewer CIDs.

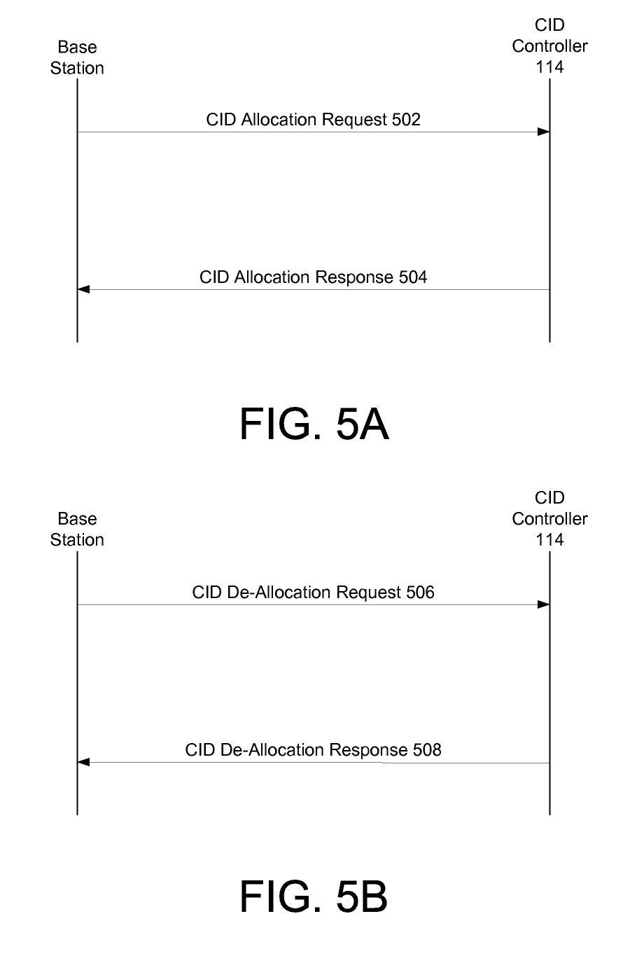

FIG. 5A is a vertical-time sequence diagram showing a base station request the CID controller 114 to allocate a CID to the base station. The base station, which may include any base station within a frequency reuse group managed by the CID controller 114, may determine that one or more CIDs is needed to serve the base station's cell. This determination may be made, for example, based on a mobile station 102 entering the wireless network 100 within the base station's cell. Based on determining that one or more CIDs is needed, the base station may send a CID allocation request message 502 to the CID controller 114. The CID allocation request message 502 may, for example, include a base station ID identifying the base station, and may include a number of CIDs needed.

In response to receiving the CID allocation request message 502, the CID controller 114 may determine if the requested number of CIDs is available, and if so, which CIDs are available. Based on determining if the requested number of CIDs is available, the CID controller 114 may send a CID allocation response message 504 to the base station. The CID allocation response message 504 may include the base station ID. If the CID controller 114 determined that the requested number of CIDs was available, the CID allocation response message 504 may include that number of CIDs allocated to the base station; if the CID controller 114 determined that the requested number of CIDs was not available, the CID allocation response message 504 may include the available number, or some other lesser number, of CIDs allocated to the base station. The CIDs allocated to the base station may be continuous, such as numbers 100-110, or may be discontinuous, isolated numbers, or a combination. The CID controller 114 may update its log to reflect the assignment of the CID(s) to the base station.

FIG. 5B is a vertical-time sequence diagram showing a base station request the CID controller 114 to de-allocate the CID from the base station. The base station may determine to de-allocate one or more CIDs based, for example, on a mobile station 102 served by the base station powering off, or leaving the wireless network 100 or CID reuse group. The CID(s) may be de-allocated from the base station which owns the CID(s). If the base station currently serving the mobile station 102 which powered off or left the wireless network 100 owns the CID(s), this base station may de-allocate the CID(s). If this base station does not own the CID(s), this base station may inform the base station which does own the CID(s), of the CID controller 114, that the CID(s) has been released by this base station; the CID(s) may thereafter be released, de-allocated, or re-allocated.

Based on the determination to de-allocate the one or more CIDs, the owning base station may send a CID de-allocation request 506 to the CID controller 114. The CID de-allocation request 506 may include, for example, a base station ID identifying the base station, and the one or more CIDs to be de-allocated from the base station.

In response to receiving the CID de-allocation request 506, the CID controller 114 may update its log to reflect the availability of the CID(s) included in the CID de-allocation request 506. The CID(s) may thereafter be available to be allocated to another base station. Also in response to receiving the CID de-allocation request 506, the CID controller 114 may send a CID de-allocation response message 508 to the base station confirming that the CID(s) have been de-allocated.

The uniqueness of the CIDs within the CID reuse cell group may, according to an example embodiment, remove the need to assign a new CID(s) to the mobile station 102 when the mobile station 102 moves from a serving cell 104 to a target cell 108 within the CID reuse group. The mobile station 102 may, for example, hand over from a serving base station 106 to a target base station 110 according to any of the handover procedures described with reference to FIG. 2A, 2B, 2C, 2D, 3A, 3B, 3C, or 3D, except as otherwise described herein.

For example, the mobile station 102 may use a first CID for communication with the serving base station 106. The mobile station 102 may perform a handover from the serving base station 106 to the target base station 110. After the handover, the mobile station 102 may continue to use the first, or “old,” CID for communication with the target base station 110.

In another example, the target base station 110 may receive, from the serving base station 106, a request to use an old CID(s) for communication with the mobile station. The request may be included in the base station-to-base station handover message, such as the handover pre-notification message 206 or handover pre-notification message 207. The old CID(s) may be owned by a different base station from the target base station 110, such as by the serving base station 106. The target base station 110 may determine that communication may be performed between the target base station 110 and the mobile station 102 using the old CID(s). The target base station 110 may determine that communication may be performed between the target base station 110 and the mobile station 102 using the old CID(s) based, for example, on determining that the old CID(s) is not already being used by the target base station 110 to identify a connection(s) with another mobile station.

The reuse of the CID(s) by the mobile station 102 may remove the need for the serving base station 106 and/or target base station 110 to provide a new CID(s) to the mobile station 102 within the base station handover response message 212, base station handover request message 213, or fast ranging information element 218. Context information for the mobile station 102, such as the CID(s), base station which owns the CID(s), and/or the type of data flow for the mobile station 102, may be transferred to the target base station 110 through a backbone of the wireless network 100; the backbone may include, for example, the base stations such as the serving base station 106 and the target base station 110, the gateway 112, the CID controller 114, and/or a mobile switching manager (not shown). The serving base station 106 and/or target base station 110 may or may not provide the old CID(s), which was used to identify the connection between the mobile station 102 and the serving base station 106, to the mobile station 102 within the base station handover response message 212, base station handover request message 213, or fast ranging information element 218.

When the mobile station 102 moves out of a cell served by a base station to which the CID(s) were allocated into a different cell served by a different base station, such as from the serving cell 104 into the target cell 108, the target base station 110 may “borrow” the CID(s) from the serving base station 106, which may be considered the “owner” of the CID. If the mobile station 102 moves out of the target cell 108 into a third cell (not shown), a third base station (not shown) may “borrow” the CID.

For example, if the mobile station 102 moves from the serving cell 104 to the target cell 108, the mobile station 102 may, in response to receiving a scheduling message such as the fast ranging information element 218 from the target base station 218, determine whether to transmit the old CID(s) used with the serving base station 106 or a new CID(s) for communication with the target base station 110. The scheduling message may, for example, allocate resources for the old CID(s) or new CID(s).

Based on the determining, the mobile station 102 may transmit the range request message 220 to the target base station 110. The range request message 220 may include, based on the determining, either the old CID(s) that was used by the serving base station 106 for the mobile station 102 to identify the mobile station 102 to the serving base station 106, or a new CID(s) for communicating with the target base station 110.

Upon receipt of the range request message 220 by the target base station 110, communication may be established between the mobile station 102 and the target base station 110. If the mobile station 102 and target base station 110 use the new CID(s) for communication, the target base station 110 may send the CID controller 114 a CID de-allocation request 506, as described with reference to FIG. 5B, according to an example embodiment. Or, the target base station 110 may inform the serving base station 106 of the use of the new CID(s), and the serving base station 106 may send the CID deallocation request 506 to the CID controller 114.

The range request message 220 may include the old CID(s). In an example embodiment, the old CID(s) may collide with the target base station's 110 CID space because the CID(s) were already allocated to the target base station 110 and/or used by a mobile station served by the target base station 110. If such a collision occurs, the target base station 110 may assign or allocate a new CID(s) to the mobile station 102, such as by including the new CID(s) in a range response message (not shown) sent by the target base station 110 to the mobile station 102.

In another example embodiment, if the target base station 110 determines to reuse the old CID(s) to communicate with the mobile station 102, the target base station 110 may determine the likelihood of a CID collision with the CID space of the serving cell 104. If the target base station 110 determines that the likelihood of CID collision is medium or high, the target base station may borrow the CID(s) from the serving base station 106 (or other base station which owns the CID(s)), temporarily preventing the serving base station from further use of the CID(s). If the target base station 110 determines that the likelihood of CID collision is low, the target base station 110 may inform the serving base station 106 (or other base station which owns the CID(s)) that the CID(s) may be reused.

Once communication is established between the mobile station 102 and the target base station 110, the mobile station 102 may transmit one or more data packets, such as the packet 400 shown in FIG. 4, to the target base station 110, using the old CID(s). The one or more data packets may include MPDUs. The old CID(s) may be the CID(s) which identified the connection between the mobile station 102 and the serving base station 106 when the mobile station 102 was communicating with the serving base station 106. The old CID(s) may include an old CID for each of a plurality of service flows associated with or identifying the mobile station 102 to the serving base station 106.

According to an example embodiment, the mobile station 102 may transmit the one or more packets to the target base station 110 using the old CID(s), based on the mobile station 102 not receiving a range response message (not shown) from the target base station 110 within a timeout period. The mobile station 102 may also transmit the one or more packets to the target base station 110 using the old CID(s) based on receiving the scheduling message or fast ranging information element 218, the scheduling message including the old CID(s). The mobile station 102 may also send or transmit the one or more packets to the target base station 110 using the old CID(s) based on receiving a downlink map (DL-Map, not shown) or uplink map (UL-Map) allocating resources for the old CID(s).

The packets may include the old CID(s) in a MAC header (such as the MAC header 402 shown in FIG. 4), according to an example embodiment. If the mobile station 102 does receive the range response message within the timeout period, the mobile station 102 may use a new CID(s) included in the range response message.

If the mobile station 102 moves into a cell which is not part of the CID reuse group, the mobile station 102 may be assigned a new CID(s) according to any of the procedures described with reference to FIG. 2A, 2B, 2C, 2D, 3A, 3B, 3C, or 3D.

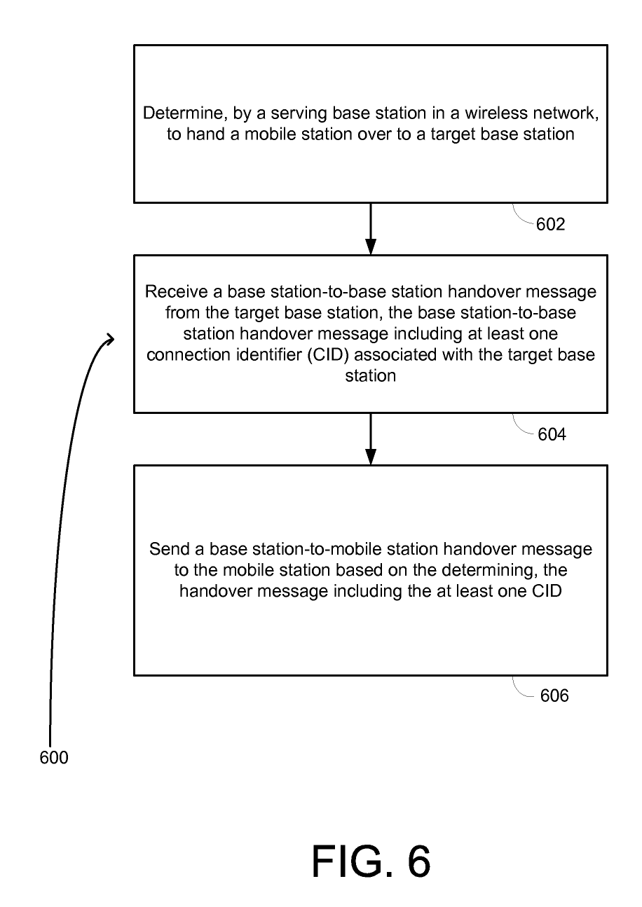

FIG. 6 is a flowchart showing a method 600 according to an example embodiment. According to this example, the method 600 may include determining, by a serving base station in a wireless network, to hand a mobile station over to a target base station (602). The method 600 may also include receiving a base station-to-base station handover message from the target base station, the base station-to-base station handover message including at least one connection identifier (CID) associated with the target base station (604). The method 600 may also include sending a base station-to-mobile station handover message to the mobile station based on the determining, the handover message including the at least one CID (606).

According to an example embodiment, the determining may include determining to hand the mobile station over to the target base station based on receiving a handover request from the mobile station.

According to an example embodiment, the method 600 may further comprise receiving a handover request from the mobile station. In this example, the determining may include determining to hand the mobile station over to the target base station based on the receiving the handover request from the mobile station.

According to an example embodiment, the determining may include determining to hand the mobile station over to the target base station based on a determined distance of the mobile station from the serving base station and the target base station.

According to an example embodiment, the determining may include determining to hand the mobile station over to the target base station based on a handshake procedure with the target base station.

According to an example embodiment, the determining may include determining to hand the mobile station over to the target base station based on a handshake procedure with the target base station and a gateway which manages the serving base station and the target base station.

According to an example embodiment, the method 600 may further include sending, by the serving base station, a handover request to the target base station. In this example, the method 600 may also include sending, by the target base station, a scheduling message to the mobile station in response to receiving the handover request from the serving base station. In this example, the method 600 may also include receiving, by the target base station, a data packet from the mobile station without receiving a range request from the mobile station, the data packet being received in accordance with the scheduling message and including an authentication code.

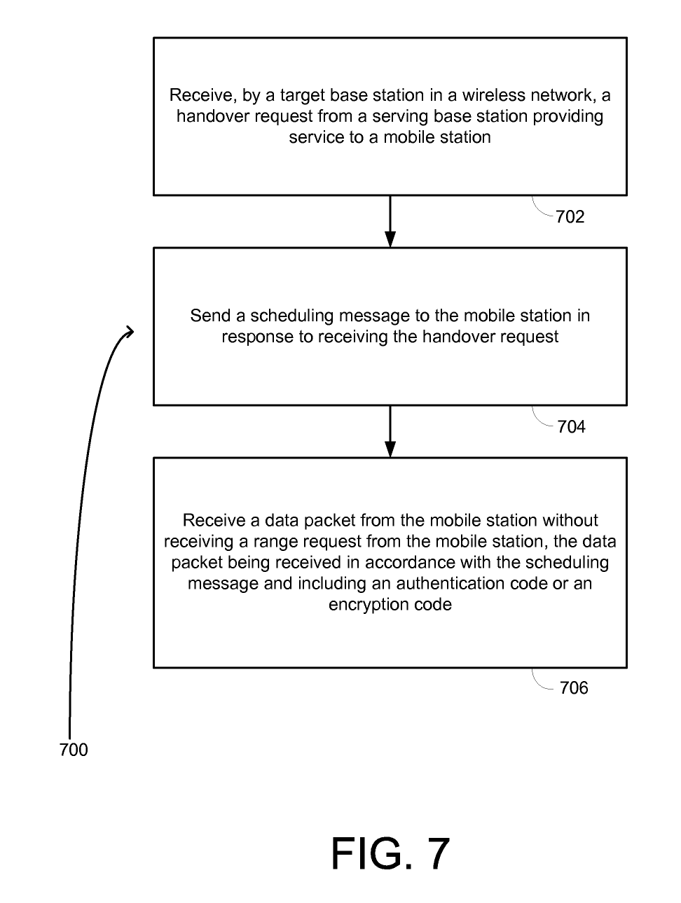

FIG. 7 is a flowchart showing a method 700 according to another example embodiment. According to this example, the method 700 may include receiving, by a target base station in a wireless network, a handover request from a serving base station providing service to a mobile station (702). The method 700 may also include sending a scheduling message to the mobile station in response to receiving the handover request (704). The method 700 may also include receiving a data packet from the mobile station without receiving a range request from the mobile station, the data packet being received in accordance with the scheduling message and including an authentication code or an encryption code (706).

According to an example embodiment, the receiving the handover message may include receiving a handover pre-notification.

According to an example embodiment, the receiving the handover message may include receiving a handover confirmation.

According to an example embodiment, receiving the handover message from the serving base station serving the mobile station may include receiving the handover message from a gateway managing the target base station and the mobile station.

According to an example embodiment, the receiving the data packet may include receiving a first MAC protocol data unit (MPDU) packet.

According to an example embodiment, the receiving the data packet from the mobile station may include receiving the data packet from the mobile station, the data packet including the authentication code, the authentication code being calculated by encrypting a portion of the data packet.

According to an example embodiment, the receiving the first data packet from the mobile station may include receiving the data packet from the mobile station, the first data packet including the authentication code, the authentication code being calculated by encrypting a MAC address included in the data packet.

According to an example embodiment, the receiving the first data packet from the mobile station may include receiving the data packet from the mobile station, the first data packet including the authentication code, the authentication code being calculated by executing a Hash Message Authentication Code on a portion of the data packet.

According to an example embodiment, the receiving the first data packet from the mobile station may include receiving the data packet from the mobile station, the first data packet including the authentication code, the authentication code being calculated by executing a Ciphered Message Authentication Code on a portion of the data packet.

According to an example embodiment, the method 700 may further comprise receiving a second data packet from the mobile station, the second data packet including the authentication code.

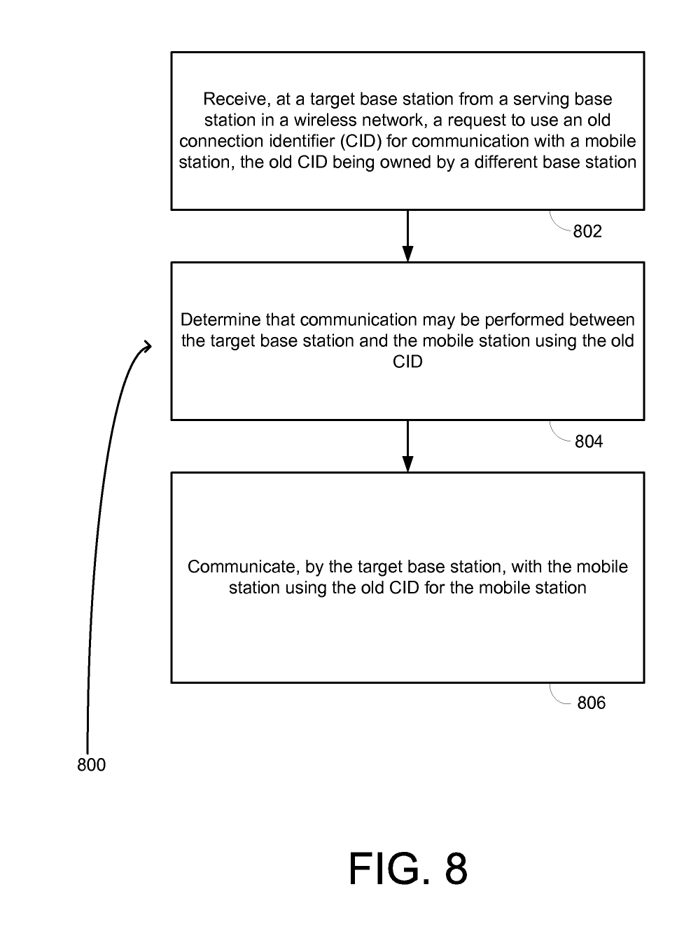

FIG. 8 is a flowchart showing a method 800 according to another example embodiment. According to this example, the method 800 may comprise receiving, at a target base station from a serving base station in a wireless network, a request to use an old connection identifier (CID) for communication with a mobile station, the old CID being owned by a different base station (802). The method 800 may also include determining that communication may be performed between the target base station and the mobile station using the old CID (804). The method 800 may also include communicating, by the target base station, with the mobile station using the old CID for the mobile station (806).

According to an example embodiment, the receiving the request may include receiving, at the target base station from the mobile station, the request to use the old CID for communication with the target base station, the old CID being owned by the different base station, the different base station including the serving base station.

According to an example embodiment, the determining may include determining that communication may be performed between the target base station and the mobile station using the old CID based on determining that the old CID is not already being used by the target base station.

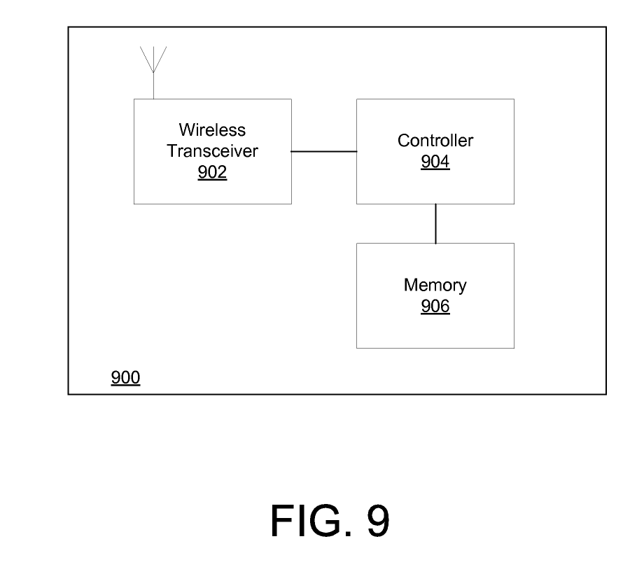

FIG. 9 is a block diagram of a wireless station 900 according to an example embodiment. The wireless station 900 (e.g. mobile station 102, serving base station 106, or target base station 110) may include, for example, a wireless transceiver 902 to transmit and receive signals, a controller 904 to control operation of the station and execute instructions or software, and a memory 906 to store data and/or instructions.

Controller 904 may be programmable and capable of executing software or other instructions stored in memory or on other computer media to perform the various tasks and functions described above, such as one or more of the tasks or methods described above.

In addition, a storage medium may be provided that includes stored instructions, which when executed by a controller or processor may result in the controller 904, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
determining, by a serving base station in a wireless network, to hand a mobile station over to a target base station;
receiving a base station-to-base station handover message from the target base station, the base station-to-base station handover message including at least one connection identifier (CID) associated with the target base station; and
sending a base station-to-mobile station handover message to the mobile station based on the determining, the handover message including the at least one CID.

2. The method of claim 1, wherein the determining includes determining to hand the mobile station over to the target base station based on receiving a handover request from the mobile station.

3. The method of claim 1, further comprising:
receiving a handover request from the mobile station,
wherein the determining includes determining to hand the mobile station over to the target base station based on the receiving the handover request from the mobile station.

4. The method of claim 1, wherein the determining includes determining to hand the mobile station over to the target base station based on a determined distance of the mobile station from the serving base station and the target base station.

5. The method of claim 1, wherein the determining includes determining to hand the mobile station over to the target base station based on a handshake procedure with the target base station.

6. The method of claim 1, wherein the determining includes determining to hand the mobile station over to the target base station based on a handshake procedure with the target base station and a gateway which manages the serving base station and the target base station.

7. The method of claim 1, further comprising:
sending, by the serving base station, a handover request to the target base station;
sending, by the target base station, a scheduling message to the mobile station in response to receiving the handover request from the serving base station; and
receiving, by the target base station, a data packet from the mobile station without receiving a range request from the mobile station, the data packet being received in accordance with the scheduling message and including an authentication code.

8. A method comprising:
receiving, by a target base station in a wireless network, a handover request from a serving base station providing service to a mobile station;
sending a scheduling message to the mobile station in response to receiving the handover request; and
receiving a data packet from the mobile station without receiving a range request from the mobile station, the data packet being received in accordance with the scheduling message and including an authentication code or an encryption code.

9. The method of claim 8, wherein the receiving the handover message includes receiving a handover pre-notification.

10. The method of claim 8, wherein the receiving the handover message includes receiving a handover confirmation.

11. The method of claim 8, wherein the receiving the handover message from the serving base station serving the mobile station includes receiving the handover message from a gateway managing the target base station and the mobile station.

12. The method of claim 8, wherein:
the receiving the data packet includes receiving a first MAC protocol data unit (MPDU) packet.

13. The method of claim 8, wherein the receiving the data packet from the mobile station includes receiving the data packet from the mobile station, the data packet including the authentication code, the authentication code being calculated by encrypting a portion of the data packet.

14. The method of claim 8, wherein the receiving the first data packet from the mobile station includes receiving the data packet from the mobile station, the first data packet including the authentication code, the authentication code being calculated by encrypting a MAC address included in the data packet.

15. The method of claim 8, wherein the receiving the first data packet from the mobile station includes receiving the data packet from the mobile station, the first data packet including the authentication code, the authentication code being calculated by executing a Hash Message Authentication Code on a portion of the data packet.

16. The method of claim 8, wherein the receiving the first data packet from the mobile station includes receiving the data packet from the mobile station, the first data packet including the authentication code, the authentication code being calculated by executing a Ciphered Message Authentication Code on a portion of the data packet.

17. The method of claim 8, further comprising receiving a second data packet from the mobile station, the second data packet including the authentication code.

18. A method comprising:
receiving, at a target base station from a serving base station in a wireless network, a request to use an old connection identifier (CID) for communication with a mobile station, the old CID being owned by a different base station;
determining that communication may be performed between the target base station and the mobile station using the old CID; and
communicating, by the target base station, with the mobile station using the old CID for the mobile station.

19. The method of claim 18, wherein the receiving the request includes receiving, at the target base station from the mobile station, the request to use the old CID for communication with the target base station, the old CID being owned by the different base station, the different base station including the serving base station.

20. The method of claim 18, wherein the determining includes determining that communication may be performed between the target base station and the mobile station using the old CID based on determining that the old CID is not already being used by the target base station.
